(19) United States
(12) Patent Application Publication
(10) Pub. No.: US 2010/0188204 A1
(43) Pub. Date: Jul. 29, 2010

(54) DISPLAY DEVICE FOR VEHICLE

(76) Inventors: Reiko Okada, Tokyo (JP); Kiyoshi Matsutani, Tokyo (JP); Atsushi Kohno, Tokyo (JP); Yuta Kawana, Tokyo (JP); Masami Aikawa, Tokyo (JP)

Correspondence Address: BIRCH STEWART KOLASCH & BIRCH, PO BOX 747, FALLS CHURCH, VA, 22040-0747, US

(21) Appl. No.: 12/664,864

(22) PCT Filed: Jun. 30, 2008
(86) PCT No.: PCT/JP2008/001704

§ 371 Date: Dec. 15, 2009

(30) Foreign Application Priority Data
Oct. 15, 2007 (JP) 2007-268121

(51) Int. Cl. B60Q 3/04; G09G 5/00

(52) U.S. Cl. 340/457.1; 345/7

(57) ABSTRACT

A display device for vehicles has a screen 2 that is composed of a soft material and is mounted on a surface of a panel 6 installed in front of a seat; a projection unit 1 that is mounted at the back of the panel and generates projection light to be projected onto the screen to form an image, reflection components 3₁-3₂ for reflecting the projection light generated by the projection unit, and a light-guiding component 4 for having the reflection components reflect the projection light a plurality of times to guide it to the screen.

### TECHNICAL FIELD

The present invention relates to a display device for vehicles for displaying various information items in a vehicle, and particularly to a technique for installing a projection type display device on a vehicle.

### BACKGROUND ART

Generally, as a display device for a person who sits on the passenger seat of a vehicle to view various images, a display device for a car navigation system is used in common with it. Such a display device is generally placed at the center of the front panel considering that a driver will watch it. The screen of the display device placed at the center of the front panel, however, makes it difficult to view from the passenger seat because of a viewing angle. In addition, since the area at the center of the front panel is spatially limited, a large-screen display device cannot be installed.

Furthermore, mounting a display device such as a liquid crystal monitor in front of the passenger seat is undesirable from a viewpoint of avoiding a danger of the person who sits on the passenger seat in case of a sudden stop. Besides, trying to mount the display device in front of the passenger seat presents a problem of interfering with the mounting position of an air bag, or hindering the operation of the air bag.

As one of the techniques for solving such problems, a technique has been known which displays various information items using a projection type display device. For example, Patent Document 1 discloses an air bag structure of a vehicle, which facilitates the placement of a projection type instrument display device. In the air bag structure of the vehicle, a bag container, which is mounted on a portion of the instrument panel opposing the driver's seat and has an opening opened or closed with a lid constituting an upper portion of the instrument panel, stores the main part of the air bag which is stored together with a deflated inflator and shifts from the deflated state to the inflated state into the vehicle through the opening by the operation of the inflator, and a projection reflector section associated with the projection type instrument display device is formed at a side of the driver's seat in the bag container. The projection type instrument display device shows information such as a running speed, engine speed and fuel remaining quantity to an occupant by reflecting the information once from a mirror and projecting on a meter window. This makes it possible to place the projection type instrument and the like without interfering with the other components.

In addition, Patent Document 2 discloses a projection type display device for vehicles capable of establishing a sufficient distance as an optical path length even within the instrument panel, and of improving the degree of freedom of the layout tremendously. In the projection type display device for vehicles, the optical path of projection light guided by a light-guiding component for guiding the projection light from a projection component to a screen is formed in such a manner as to surround the steering member, a long component which is mounted within the instrument panel in the vehicle and extends in the lateral direction of the vehicle. This enables the projection type display device for vehicles to be laid out in such a manner as to prevent the interference with the other components mounted within the instrument panel while maintaining a prescribed projection distance.

Patent Document 1: Japanese Patent Laid-Open No. 7-25306/1995.

Patent Document 2: Japanese Patent Laid-Open No. 2005-156848.

However, the technique disclosed in Patent Document 1 has a disadvantage of being unable to display the information on a large-screen because the optical path from the projection type instrument display device to the meter window is not enough because the projection light produced from the projection type instrument display device is reflected off the mirror only once before projected onto the meter window.

In addition, although the technique disclosed in Patent Document 2 forms the optical path of projection light guided by the light-guiding component for guiding the projection light from the projection component to the screen in such a manner as to surround the steering member, a long component which is mounted within the instrument panel and extends in the lateral direction of the vehicle, a technique is desired which enables mounting the projection component and the screen on desired locations. In addition, it is desired to develop a display device for vehicles capable of circumventing a danger at a sudden stop.

The present invention is implemented to solve the foregoing disadvantages and to meet the foregoing demands, and its subject is to provide a display device for vehicles capable of extending the optical path length of the projection light, of mounting the projection component and the screen on any desired locations, and of avoiding the danger at a sudden stop.

### DISCLOSURE OF THE INVENTION

To solve the foregoing problems, a display device for vehicles in accordance with the present invention has a screen that is composed of a soft material and is mounted on a surface of a panel in front of a seat; a projection unit that is mounted at the back of the panel and generates projection light projected onto the screen to form an image; and a light-guiding component that includes a reflection component for reflecting the projection light generated by the projection unit, and guides the projection light by reflecting it a plurality of times with the reflection component.

According to the display device for vehicles in accordance with the present invention, since it is constructed in such a manner as to reflect the projection light generated by the projection unit 1 a plurality of times with the plurality of reflection components mounted in the light-guiding component so as to display on the screen, it can maintain the long optical path. As a result, it can display the image on the screen mounted on the instrument panel in a large scale. In addition, since the screen is composed of a soft material, it can ensure safety of the occupant even if the vehicle makes a sudden stop in the event of collision, for example.

### BRIEF DESCRIPTION OF THE DRAWINGS

FIG. 1 is a side view showing a structure of a display device for vehicles of an embodiment 1 in accordance with the present invention;

FIG. 2 is a side view showing another structure of the display device for vehicles of the embodiment 1 in accordance with the present invention;

FIG. 3 is a side view showing a structure of a display device for vehicles of an embodiment 2 in accordance with the present invention;

FIG. 4 is an external perspective view of a display device for vehicles of an embodiment 3 in accordance with the present invention;

FIG. 5 is a diagram showing layouts of a projection unit, a screen and reflection components of a display device for vehicles of an embodiment 4 in accordance with the present invention;

FIG. 6 is a diagram showing a structure of a display device for vehicles of an embodiment 5 in accordance with the present invention;

FIG. 7 is a side view showing a structure of a screen mounting section of a display device for vehicles of an embodiment 6 in accordance with the present invention;

FIG. 8 is a side view showing a screen portion of a display device for vehicles of an embodiment 7 in accordance with the present invention;

FIG. 9 is a side view showing a structure of a display device for vehicles of an embodiment 8 in accordance with the present invention;

FIG. 10 is a block diagram showing an electrical configuration of a display device for vehicles of an embodiment 9 in accordance with the present invention;

FIG. 11 is a flowchart showing the operation of the display device for vehicles of the embodiment 9 in accordance with the present invention centering on air bag control processing;

FIG. 12 is a block diagram showing an electrical configuration of a display device for vehicles of an embodiment 10 in accordance with the present invention;

FIG. 13 is a block diagram showing an electrical configuration of a display device for vehicles of an embodiment 11 in accordance with the present invention;

FIG. 14 is a flowchart showing the operation of the display device for vehicles of the embodiment 11 in accordance with the present invention centering on luminance altering processing by illuminance;

FIG. 15 is a flowchart showing the operation of the display device for vehicles of the embodiment 11 in accordance with the present invention centering on luminance altering processing by time;

FIG. 16 is a block diagram showing an electrical configuration of a display device for vehicles of an embodiment 12 in accordance with the present invention; and

FIG. 17 is a flowchart showing the operation of the display device for vehicles of the embodiment 12 in accordance with the present invention centering on projection processing.

### BEST MODE FOR CARRYING OUT THE INVENTION

The best mode for carrying out the invention will now be described with reference to the accompanying drawings to explain the present invention in more detail.

### Embodiment 1

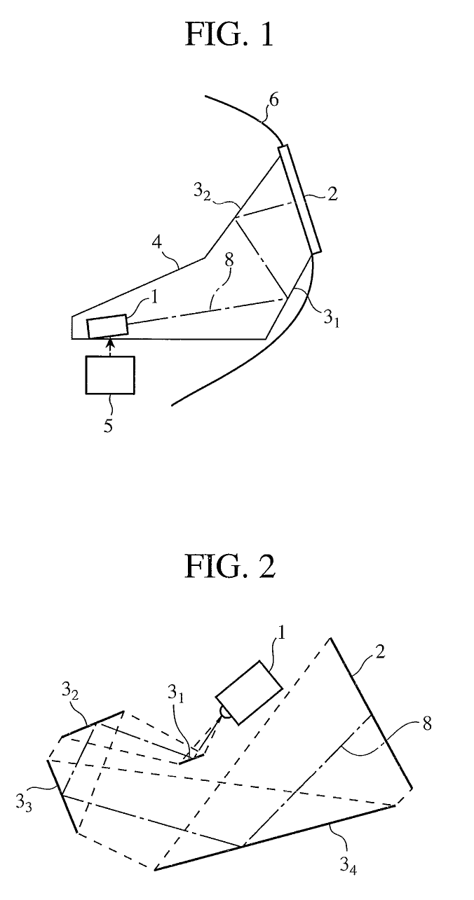

FIG. 1 is a side view showing a structure of a display device for vehicles of an embodiment 1 in accordance with the present invention. The display device for vehicles has a projection unit 1, a screen 2, a plurality of reflection components 3₁ and 3₂, a light-guiding component 4, a display generating unit 5 and an instrument panel 6.

The projection unit 1, which is also called a projector, is placed at the back of the instrument panel 6. The projection unit 1 generates projection light in response to a video signal sent from the display generating unit 5. The projection light the projection unit 1 generates is projected onto the screen 2 to form an image.

The screen 2 is a rear projection screen composed of a soft material such as a milk white or gray semitransparent vinyl material, which displays an image that will become a normal picture when seen from its front side by projecting light from its back. The screen 2 is mounted on the surface of the instrument panel 6 in front of the passenger seat.

The light-guiding component 4 is a darkroom formed to guide the projection light the projection unit 1 generates to the screen 2. The light-guiding component 4 includes a plurality of reflection components 3₁ and 3₂ which consist of a mirror, for example, and reflect the projection light the projection unit 1 generates a plurality of times to guide it to the screen 2. The path along which the projection light the projection unit 1 generates reaches the screen 2 is referred to as an optical path 8.

The display generating unit 5, which is composed of a personal computer or a DVD (Digital Versatile Disk) unit, for example, generates a video signal from the data recorded on a storage medium and delivers it to the projection unit 1. The display generating unit 5 is connected with the projection unit 1 via a cable or by wireless.

Next, the operation of the display device for vehicles of the embodiment 1 in accordance with the present invention with the foregoing configuration will be described. The video signal generated by the display generating unit 5 is delivered to the projection unit 1 via a cable or by wireless. The projection unit 1 generates the projection light corresponding to the video signal sent from the display generating unit 5. The projection light the projection unit 1 generates has its optical path bent because of the reflection from the plurality of reflection components 3₁ and 3₂ mounted in the light-guiding component 4, and arrives at the back of the screen 2. Thus, the image is formed on the screen 2 so that the occupant can view the image from the front side of the screen 2.

As described above, according to the display device for vehicles of the embodiment 1 in accordance with the present invention, since it is constructed in such a manner as to reflect the projection light generated by the projection unit 1 a plurality of times with the plurality of reflection components 3₁-3₂ mounted in the light-guiding component 4 so as to display on the screen 2, it can maintain the long optical path 8. As a result, it can display the image on the screen 2 mounted on the instrument panel 6 in a large scale. Accordingly, it is suitable for viewing an entertainment from the passenger seat, for example. In addition, since the screen 2 is composed of a soft material, it can ensure safety of the occupant even if the vehicle makes a sudden stop in a collision, for example.

Incidentally, as for the layout of the projection unit 1, screen 2 and light-guiding component 4 (including the reflection components 3₁-3₂) of the display device for vehicles shown in FIG. 1, it is only an example, and various layouts other than the layout shown in FIG. 1 are possible. For example, it is also possible to install four reflection components 3₁-3₄ in the light-guiding component 4 as shown in FIG. 2 and to form the optical path 8 in an approximately U-like shape. According to the layout, since it places the projection unit 1 above the light-guiding component 4 and bends the optical path 8 a plurality of times in multiple directions, it can maintain the long optical path 8 within a smaller space, thereby being able to display the image on a large screen.

### Embodiment 2

The display device for vehicles of an embodiment 2 in accordance with the present invention is configured in such a manner that in the display device for vehicles of the embodiment 1, the optical path is bent in such a fashion that it does not interfere with an air bag installed at the back of the instrument panel, thereby carrying out light guiding.

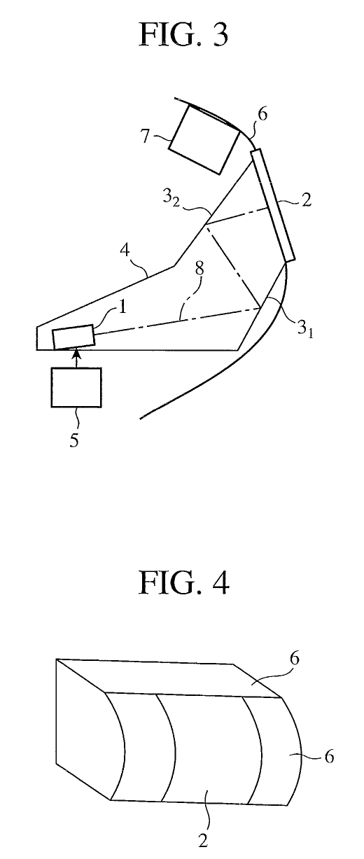

FIG. 3 is a side view showing a structure of the display device for vehicles of the embodiment 2 in accordance with the present invention. The display device for vehicles is configured in such manner that when an air bag 7 is installed at the back of the instrument panel 6 in the display device for vehicles of the embodiment 1, the shape of the light-guiding component 4 and the locations of the reflection components 3₁-3₂ are determined in such a manner as to avoid the location of the air bag.

According to the display device for vehicles of the present embodiment 2, since it can place the light-guiding component 4 in such a manner as to avoid the interference with the air bag 7, it can increase the degree of freedom of the layout of the projection unit 1, screen 2 and light-guiding component 4 (including reflection components 3₁-3₂). In addition, even in case of operation of the air bag 7 in a collision of the vehicle, since nothing that will block the air bag 7 is placed in the direction of inflation, the air bag 7 can operate normally.

### Embodiment 3

The display device for vehicles of an embodiment 3 in accordance with the present invention has a screen curved along the shape of the instrument panel in the display device for vehicles of the embodiment 1.

FIG. 4 is an external perspective view of the display device for vehicles of the embodiment 3 in accordance with the present invention. In the display device for vehicles, the screen 2 of the display device for vehicles of the embodiment 1 is composed of a soft flexible material such as vinyl or film, and if the instrument panel 6 has a curved surface, the screen 2 is mounted along the curve.

Since an ordinary display device (liquid crystal monitor, for example) can be mounted only on a flat surface, only a display device with a small screen can be mounted when the vehicle has only a small flat surface. However, according to the display device for vehicles of the present embodiment 3, a large screen can be mounted even if there is only a curved surface in the vehicle, and hence it can be made fit to the interior of the vehicle in the design.

Incidentally, as for the curved surface formed by bending the screen 2, it is not limited to a second-degree curved surface as shown in FIG. 4, but a third-degree curved surface can also be employed.

### Embodiment 4

The display device for vehicles of an embodiment 4 in accordance with the present invention is configured in such a manner as to bend the optical path of the projection light in three-dimensional directions in the display device for vehicles of the embodiment 1.

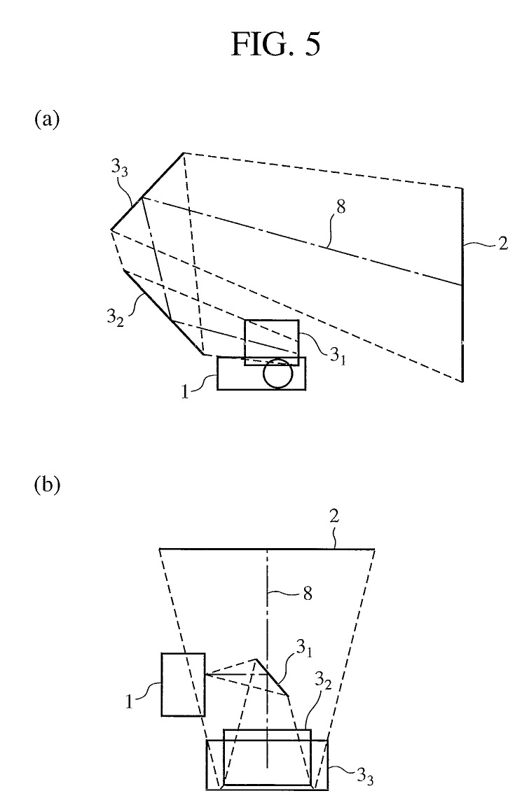

FIG. 5 is a diagram showing a layout of the projection unit 1, screen 2 and reflection components 3₁-3₃ of the display device for vehicles of the embodiment 4 in accordance with the present invention: FIG. 5(a) is a side view; and FIG. 5(b) is a top view. As shown in FIG. 5, in the display device for vehicles, the light-guiding component 4 is shaped and the reflection components 3₁-3₃ are arranged in such a manner as to bend the optical path 8 of the projection light the projection unit 1 generates not only in the vertical direction, but also in the lateral direction with respect to the screen 2, that is, in the three-dimensional directions.

According to the display device for vehicles of the present embodiment 4, since it can form the optical path in lateral direction even if the space is limited in the direction from front to back of the instrument panel 6 or in the vertical direction thereof, it can display an image on a large screen using a limited space.

### Embodiment 5

The display device for vehicles of an embodiment 5 in accordance with the present invention alters the structure of the screen itself in order to facilitate the operation of the air bag in the display device for vehicles of the embodiment 2.

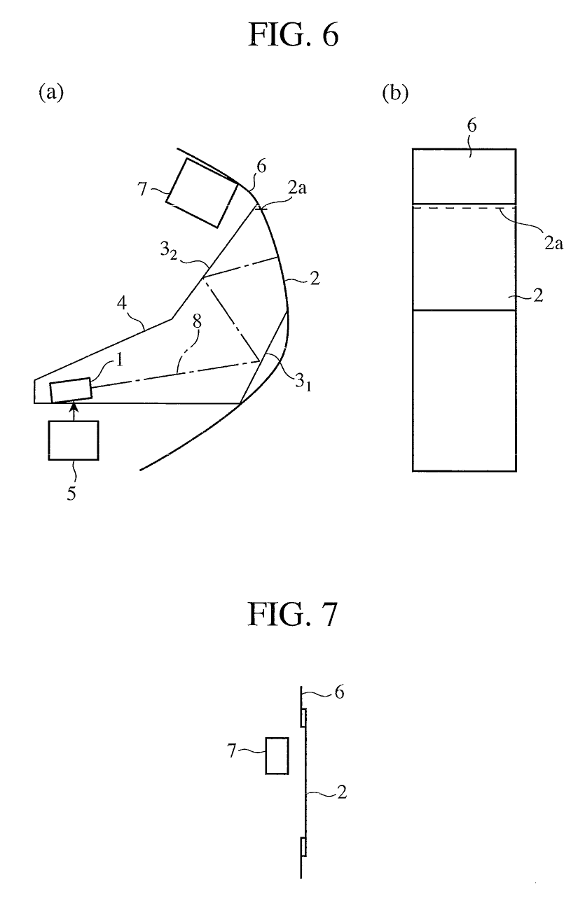

FIG. 6 is a diagram showing a structure of the display device for vehicles of the embodiment 5 in accordance with the present invention: FIG. 6(a) is a side view; and FIG. 6(b) is a partial front view. The screen 2 has a split 2a on its prescribed location so that it can be broken easily when the air bag 7 is activated and a pressure higher than a prescribed value is applied from the back of the instrument panel 6. Incidentally, the position of the split 2a shown in FIG. 6 is only an example, and it can be formed at a location other than the position shown as long as it does not affect the display and is not conspicuous.

For example, when the screen 2 is made a large-screen, or when the screen 2 is integrated in such a manner as to cover the entire surface of the instrument panel 6 in terms of designing the instrument panel 6, or when the air bag 7 is mounted at the back of the screen 2 from the viewpoint of the layout of the display device for vehicles, the screen 2 can sometimes cover a position in the direction of burst out of the air bag 7 as shown in FIG. 6. In such a case, a trouble can occur that the air bag 7 cannot inflate at a collision.

In contrast with this, according to the display device for vehicles of the embodiment 5 in accordance with the present invention, since the screen 2 is processed in such a manner as to be broken easily because of the split 2a, in case of the operation of the air bag 7 owing to a collision, it can facilitate the inflation of the air bag 7 because the screen 2 is split easily. Such a configuration is advantageous in a case of sticking the screen 2 all over the instrument panel 6 to implement a large screen or quality design.

### Embodiment 6

The display device for vehicles of an embodiment 6 in accordance with the present invention attaches the screen in such a manner as to facilitate the operation of the air bag in the display device for vehicles of the embodiment 2 to deal with the matter described in the foregoing embodiment 5.

FIG. 7 is a side view showing a structure of a screen mounting section of the display device for vehicles of the embodiment 6 in accordance with the present invention. The screen 2 is attached to the surface (occupant side) of the instrument panel 6 in such a manner that when a pressure higher than a prescribed value is applied from the back of the instrument panel 6 because of the operation of the air bag 7 owing to a collision, the screen gets out of place easily toward the front, for example, but does not get out of place easily when a pressure higher than a prescribed value is applied from the front side of the instrument panel 6.

According to the display device for vehicles of the embodiment 6 in accordance with the present invention, since the screen 2 is separated easily when the air bag 7 operates owing to a collision, it can circumvent such a situation as the air bag 7 cannot burst out because of an obstruction of the screen 2.

### Embodiment 7

The display device for vehicles of the embodiment 7 in accordance with the present invention has a deflection filter on the screen in the display device for vehicles of the embodiment 1.

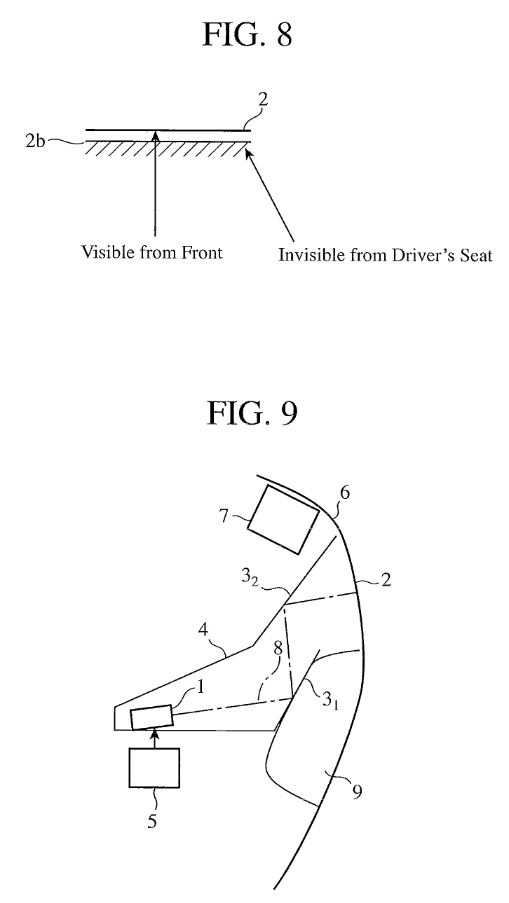

FIG. 8 is a side view showing a screen portion of the display device for vehicles of the embodiment 7 in accordance with the present invention. In the display device for vehicles, the screen 2 has on its surface a deflection filter 2b for controlling a viewing angle. As the deflection filter 2b, a deflection filter is employed which has a viewing angle that enables the image on the screen 2 to be viewed from the front direction, but that makes it difficult to be viewed from an oblique direction (from the driver's seat side).

According to the display device for vehicles of the embodiment 6 in accordance with the present invention, since only the occupant in the passenger seat can watch the image on the screen 2 but the driver in the driver's seat cannot watch it, it can lessen the danger for the driver to be attracted to the image on the screen 2 during driving, thereby being able to secure the safety during traveling.

### Embodiment 8

The display device for vehicles of an embodiment 8 in accordance with the present invention is configured in such a manner as to guide light by bending the optical path so that it does not interfere with the glove box formed at the back of the instrument panel in the display device for vehicles of the embodiment 1.

FIG. 9 is a side view showing a structure of the display device for vehicles of the embodiment 8 in accordance with the present invention. The display device for vehicles is configured in such a manner that when a glove box 9 is formed at the back of the instrument panel 6 in the display device for vehicles of the embodiment 1, the shape of the light-guiding component 4 and the locations of the reflection components 3₁-3₂ are determined in such a manner as to avoid the position of the glove box.

According to the display device for vehicles of the present embodiment 8, since the light-guiding component 4 can be placed in such a manner as to avoid the interference with the glove box 9, it can increase the degree of freedom of the layout of the projection unit 1, screen 2 and light-guiding component 4 (including the reflection components 3₁-3₂).

Incidentally, the layout of the projection unit 1, screen 2 and light-guiding component 4 (including the reflection components 3₁-3₂) in the display device for vehicles shown in FIG. 9 is only an example, and various layouts other than the layout shown in FIG. 9 can be implemented.

### Embodiment 9

The display device for vehicles of an embodiment 9 in accordance with the present invention is configured in such a manner as to stop generating the projection light by the projection unit when the air bag operates in the display device for vehicles of the embodiment 2.

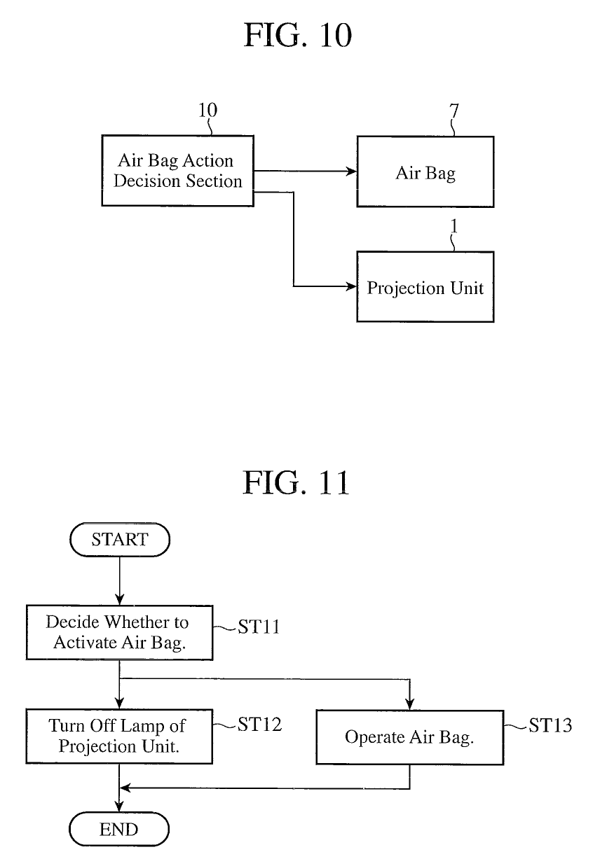

FIG. 10 is a block diagram showing an electrical configuration of the display device for vehicles of the embodiment 9 in accordance with the present invention. The display device for vehicles is configured by adding to the display device for vehicles of the embodiment 2 an air bag action decision section 10 for deciding the presence or absence of the operation of the air bag 7. The air bag action decision section 10 makes a decision whether to operate the air bag 7 or not in response to a signal sent from a collision sensor not shown, starts the air bag 7 when it makes a decision of activating the air bag 7, and turns off the lamp of the projection unit 1 to stop the generation of the projection light.

FIG. 11 is a flowchart showing the operation of the display device for vehicles of the embodiment 9 centering on the air bag control processing. The air bag control processing makes a decision whether to activate the airbag 7 or not, first (step ST11). More specifically, the air bag action decision section 10 makes a decision whether to activate the air bag 7 or not in response to the signal delivered from the collision sensor not shown. If it makes a decision of activating the air bag 7, it starts the air bag 7 (step ST13), and at the same time turns off the lamp of the projection unit 1 (step ST12). Thus, when making a decision of activating the airbag 7, the airbag action decision section 10 delivers a start signal to the air bag 7 to activate it, and delivers a lights-out signal to the projection unit 1. In this way, the air bag 7 is inflated to burst out, and the lamp of the projection unit 1 is turned off to stop generating the projection light.

As described above, according to the display device for vehicles of the embodiment 9, when the screen 2 is separated or broken because of the operation of the air bag 7 in the event of collision of the vehicle, since it turns off the lamp of the projection unit 1, it can prevent the leakage of light from the light-guiding component 4.

Incidentally, although the foregoing embodiment 9 is configured in such a manner as to turnoff the lamp of the projection unit 1 if a decision is made of activating the air bag 7, it also can be configured in such a manner as to turn off the power supply of the projection unit 1, or puts the power supply of the projection unit 1 on standby. The configuration can also prevent the leakage of light from the light-guiding component 4.

### Embodiment 10

As for the display device for vehicles of an embodiment 10 in accordance with the present invention, when an electric seat is installed in the vehicle, it displays, in the display device for vehicles of the embodiment 1, an image at a good display position in appropriate display size by operating together with the electric seat.

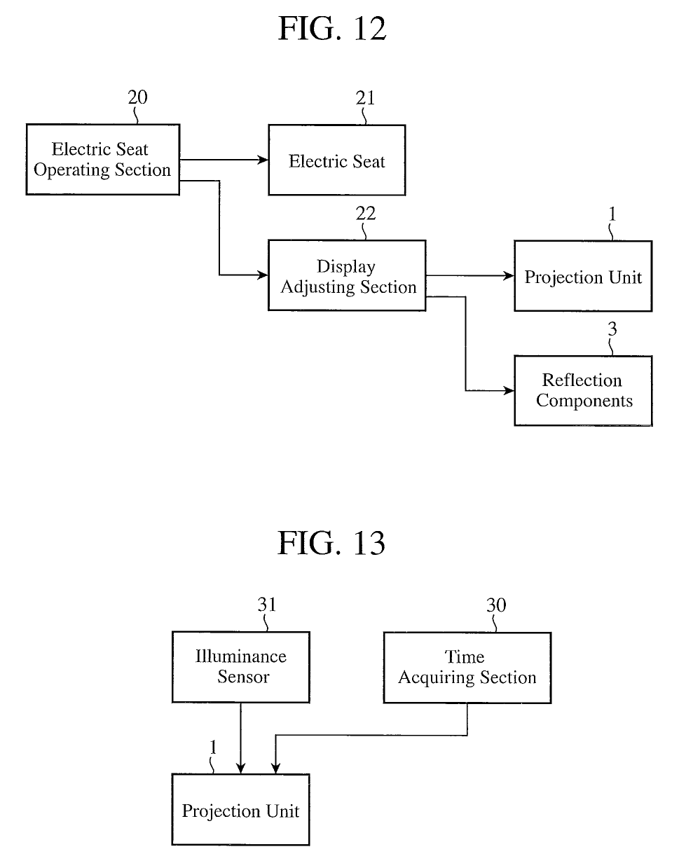

FIG. 12 is a block diagram showing an electrical configuration of the display device for vehicles of the embodiment 10 in accordance with the present invention. The display device for vehicles comprises an electric seat operating section 20 for controlling an electric seat 21, and a display adjusting section 22. Incidentally, although the details are omitted, the projection unit 1 can vary the zoom magnification, and the reflection components 3₁-3₂ are configured in such a manner as to alter their positions and angles.

The electric seat operating section 20 is used for altering the fore-and-aft position and reclining angle of the electric seat 21 by operation. An operation state signal indicating the operation state of the electric seat 21, which is generated by operating the electric seat operating section 20, is delivered to the electric seat 21 and display adjusting section 22.

In response to the operation state signal delivered from the electric seat operating section 20, the display adjusting section 22 dynamically alters the zoom magnification of the projection unit 1, or positions or angles of the reflection components 3₁-3₂. For example, when the electric seat operating section 20 is operated in such a manner as to move the electric seat 21 backward, the distance from the occupant to the screen 2 increases. Accordingly, viewing on a larger screen is suitable, and hence an image enlarged by adjusting zooming of the projection unit 1 is displayed. Incidentally, shortening the optical path 8 by altering the positions of the reflection components 3₁-3₂ can also increase the display size.

In addition, when the electric seat operating section 20 controls the electric seat 21 in such a manner as to increase the reclining angle to recline it, the direction in which the occupant is looking turns upward. Thus, an upper position is more suitable as the display position of an image, and hence the positions of the reflection components 3₁-3₂ are altered to display the image on an upper part of the screen 2. Incidentally, altering the angles of the reflection components 3₁-3₂ makes it possible to alter the display position of the image.

As described above, according to the display device for vehicles of the embodiment 10, it can display an image on the screen in the optimum display size or display position in response to the position or posture of the occupant involved in the operation of the electric seat 21.

### Embodiment 11

The display device for vehicles of an embodiment 11 in accordance with the present invention is configured in such a manner as to adjust the luminance of an image displayed on the screen in response to surrounding brightness or time in the display device for vehicles of the embodiment 1.

FIG. 13 is a block diagram showing an electrical configuration of the display device for vehicles of the embodiment 11 in accordance with the present invention. The display device for vehicles comprises in addition to the display device for vehicles of the embodiment 1 a time acquiring section 30 and an illuminance sensor 31. The time acquiring section 30 obtains the current time from a clock (not shown) mounted on the vehicle, and delivers to the projection unit 1. In addition, the illuminance sensor 31 is mounted on the front pillar, for example, to detect the surrounding brightness. The illuminance detected by the illuminance sensor 31 is delivered to the projection unit 1. In response to the current time fed from the time acquiring section 30 or the illuminance delivered from the illuminance sensor 31, the projection unit 1 adjusts the luminance of the image projected on the screen 2.

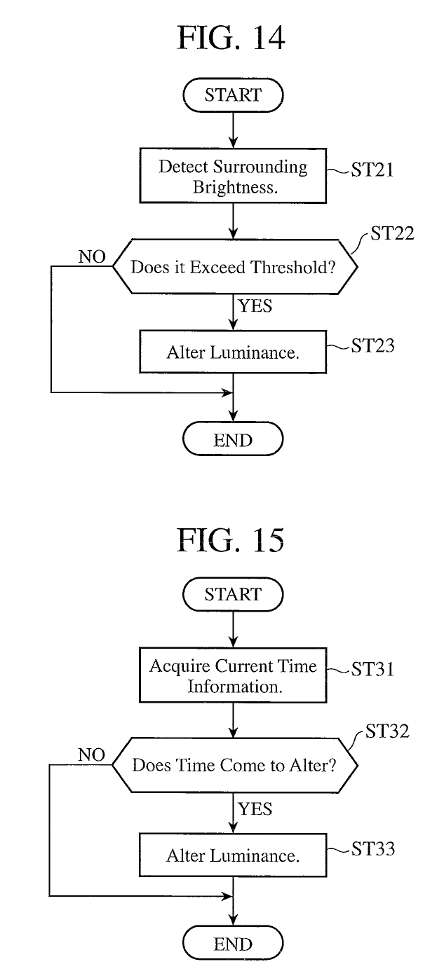

Next, the operation of the display device for vehicles of the embodiment 11 in accordance with the present invention with the foregoing configuration will be described. FIG. 14 is a flowchart showing the operation of the display device for vehicles of the embodiment 11 centering on the luminance altering processing of varying the luminance of the image displayed on the screen in response to the illuminance.

The luminance altering processing detects the surrounding brightness, first (step ST21). More specifically, the projection unit 1 acquires the surrounding illuminance from the illuminance sensor 31. Next, it checks whether the surrounding brightness exceeds a prescribed threshold or not (step ST22). More specifically, the projection unit 1 checks whether the illuminance acquired at step ST21 exceeds the prescribed threshold or not. If a decision is made at step ST22 that the surrounding brightness does not exceed the prescribed threshold, the luminance altering processing is completed.

On the other hand, if a decision is made at step ST22 that the surrounding brightness exceeds the prescribed threshold, the luminance is altered (step ST23). More specifically, the projection unit 1 increases the amount of emission of the lamp (not shown). This will increase the luminance of the image displayed on the screen 2. After that, the luminance altering processing is completed.

FIG. 15 is a flowchart showing the operation of the display device for vehicles of the embodiment 11 centering on the luminance altering processing of altering the luminance of the display image in response to time.

The luminance altering processing acquires the current time information, first (step ST31). More specifically, the projection unit 1 acquires the current time from the clock not shown. Next, it checks whether the time for alteration comes or not (step ST32). More specifically, the projection unit 1 checks whether the time acquired at step ST31 becomes the time for alteration stored in advance as the time for altering the luminance. If a decision is made at step ST32 that the time for alteration has not yet come, the luminance altering processing is completed.

On the other hand, if a decision is made at step ST32 that the time for alteration has come, the luminance is altered (step ST33). More specifically, the projection unit 1 increases the amount of emission of its own internal lamp (not shown). This will increase the luminance of the image displayed on the screen 2. After that, the luminance altering processing is completed.

As described above, according to the display device for vehicles of the embodiment 11, it can always display the image at the optimum luminance in response to the surrounding brightness.

Incidentally, although the foregoing embodiment 11 shows two examples, one of which alters the luminance in response to the illuminance, and the other of which alters the luminance in response to time, it can also be configured in such a manner as to alter the luminance of the image displayed on the screen 2 in response to the illuminance only, to the time only, or to a combination of the illuminance and time.

### Embodiment 12

The display device for vehicles of an embodiment 12 in accordance with the present invention is configured, in the display device for vehicles of the embodiment 1, in such a manner as to turn on or off the operation of the projection unit 1 in connection with the presence or absence of the seat-belt usage while the vehicle is traveling.

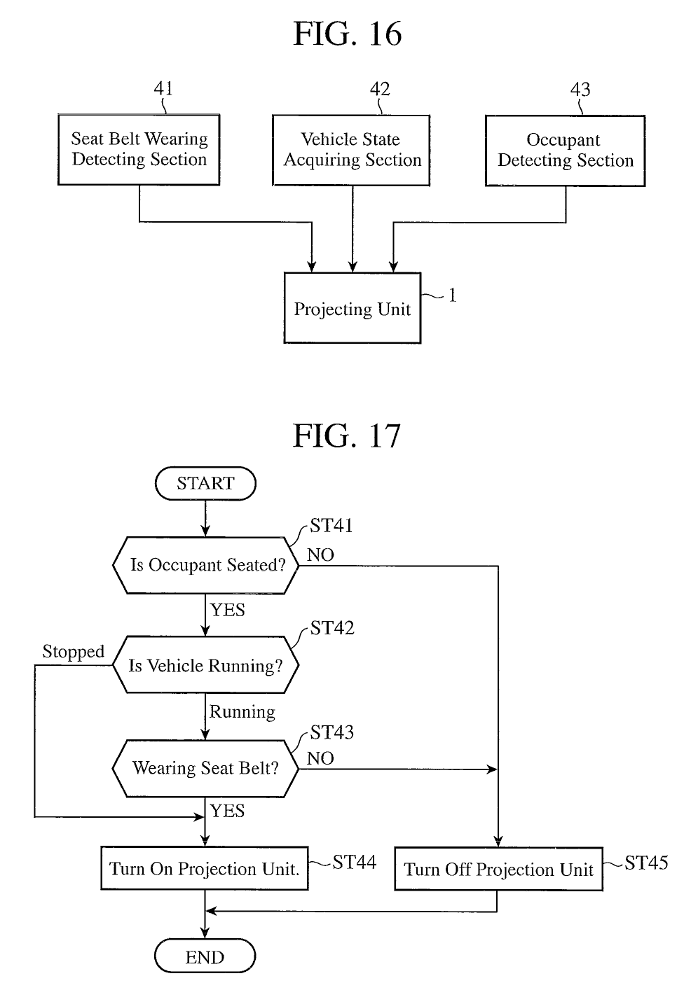

FIG. 16 is a block diagram showing an electrical configuration of the display device for vehicles of the embodiment 12 in accordance with the present invention. The display device for vehicles comprises, in addition to the display device for vehicles of the embodiment 1, a seat belt wearing detecting section 41, a vehicle state acquiring section 42 and an occupant detecting section 43.

The seat belt wearing detecting section 41, which is composed of a buckle trip switch or the like, for example, detects whether the occupant puts on the seat belt or not. The information on the presence or absence of the seat-belt usage detected by the seat belt wearing detecting section 41 is delivered to the projection unit 1.

The vehicle state acquiring section 42 acquires vehicle speed pulse information or GPS information for deciding whether the vehicle is traveling or stopped. The vehicle speed pulse information or GPS information acquired by the vehicle state acquiring section 42 is delivered to the projection unit 1 as the vehicle state information.

The occupant detecting section 43 is composed of a pressure sensor for detecting the pressure on the seat or a camera for taking a photograph of an occupant, for example, and detects whether the occupant is seated or not. The information indicating whether the occupant is detected or not by the occupant detecting section 43 is delivered to the projection unit 1.

The projection unit 1 controls the switching of its own operation in response to the information indicating whether the seat belt is worn or not delivered from the seat belt wearing detecting section 41, the vehicle state information delivered from the vehicle state acquiring section 42, and the information indicating whether the occupant is detected or not delivered from the occupant detecting section 43 (details will be described later).

Next, the operation of the display device for vehicles of the embodiment 12 in accordance with the present invention with the foregoing configuration will be described with reference to the flowchart shown in FIG. 17 centering on the projection processing that carries out the on/off control of the projection unit 1.

The projection processing checks whether the occupant is seated or not, first (step ST41). More specifically, the projection unit 1 acquires the information indicating whether the occupant is detected or not from the occupant detecting section 43, and checks whether the occupant is seated or not. If a decision is made at step ST41 that the occupant is not seated, the projection unit 1 is turned off (step ST45). More specifically, the projection unit 1 turns off its own power, for example, and stops display of the image on the screen 2.

On the other hand, when a decision is made at step ST41 that the occupant is seated, then the running state of the vehicle is checked (step ST42). More specifically, the projection unit 1 acquires the vehicle state information from the vehicle state acquiring section 42, and decides as to whether the vehicle is running or stopped. If a decision is made at step ST42 that the state of the vehicle is “stationary”, the sequence proceeds to step ST44. On the other hand, if a decision is made at step ST42 that the state of the vehicle is “running”, then a check is made whether the occupant wears the seat belt or not (step ST43). More specifically, the projection unit 1 acquires the information on the presence or absence of the seat-belt usage from the seat belt wearing detecting section 41 and checks whether the occupant wears the seat belt or not.

If a decision is made at step ST43 that the occupant does not wear the seat belt, the sequence proceeds to step ST45 to turn off the projection unit 1 as described above. On the other hand, if a decision is made at step ST43 that the occupant wears the seat belt, the sequence proceeds to step ST44. At step ST44, the projection unit 1 is turned on. More specifically, the projection unit 1 turns on its power source, for example, and displays an image on the screen 2. According to the foregoing processing, only when the occupant is seated, and when the vehicle is running and the occupant wears the seat belt, the projection unit 1 is turned on to carry out display onto the screen 2.

As described above, according to the display device for vehicles of the embodiment 12, since the projection unit 1 is turned on only when the occupant is seated with the seat belt wearing during running so as to display an image on the screen 2, it can further improve the safety.

### INDUSTRIAL APPLICABILITY

As described above, the display device for vehicles in accordance with the present invention has the screen composed of a soft material and mounted on the surface of the panel in front of a seat, and is configured in such a manner as to enable the optical path length of the projection light to be increased and the projection component and the screen to be installed at any desired positions. Accordingly, it can display an image on a large screen, and is suitable for the application to the projection type display device for vehicles capable of securing safety of the occupant even if the vehicle makes a sudden stop in the event of collision.

What is claimed is:

1. A display device for vehicles comprising:
a screen that is composed of a soft material and is mounted on a surface of a panel in front of a seat;
a projection unit that is mounted at the back of the panel, and generates projection light projected onto the screen to form an image; and
a light-guiding component that includes a reflection component for reflecting the projection light generated by the projection unit, and guides the projection light by reflecting it a plurality of times with the reflection component.

2. The display device for vehicles according to claim 1, wherein
the light-guiding component has its shape and a position of the reflection component established in a manner to avoid a position of an air bag placed at the back of the panel.

3. The display device for vehicles according to claim 1, wherein
the screen is curved and installed in a manner to have a curved surface conforming to a shape of the panel.

4. The display device for vehicles according to claim 1, wherein
the light-guiding component has its shape and a position of the reflection component established in a manner to bend an optical path of the projection light generated by the projection unit in three-dimensional directions.

5. The display device for vehicles according to claim 2, wherein
the screen has a split on its prescribed position so that the screen is broken when pressure higher than a prescribed value is applied from the back of the panel.

6. The display device for vehicles according to claim 2, wherein
the screen is mounted on the panel in a manner that the screen is disconnected when pressure higher than a prescribed value is applied from the back of the panel.

7. The display device for vehicles according to claim 1, further comprising on the surface of the screen:
a deflection filter for making it difficult to view the image on the screen from a direction of a driver's seat

8. The display device for vehicles according to claim 1, wherein
the light-guiding component has its shape and a position of the reflection component established in a manner to avoid a position of a glove box formed at the back of the panel.

9. The display device for vehicles according to claim 2, further comprising:
an air bag action deciding section for making a decision as to whether the air bag operates or not, wherein
the projection unit stops generating the projection light if the air bag action deciding section makes a decision that the air bag operates.

10. The display device for vehicles according to claim 1, further comprising:
an electric seat operating section for operating an electric seat; and
a display adjusting section for controlling alteration of a zoom magnification by the projection unit or alteration of a position and angle of the reflection component in response to the operation by the electric seat operating section.

11. The display device for vehicles according to claim 1, further comprising:
an illuminance sensor for detecting illuminance; and
a clock for measuring time, wherein
the projection unit adjusts luminance of the projection light in response to at least one of the illuminance detected by the illuminance sensor or the time measured by the clock.

12. The display device for vehicles according to claim 1, further comprising:
a vehicle state acquiring section for acquiring a state of a vehicle;
a seat belt wearing detecting section for making a decision of wearing a seat belt or not; and
an occupant detecting section for detecting whether an occupant is seated or not, wherein
the projection unit generates or stops the projection light in response to at least one of presence or absence of a seated occupant detected by the occupant detecting section, presence or absence of wearing the seat belt detected by the seat belt wearing detecting section, or a state as to whether the vehicle is running or stopped acquired by the vehicle state acquiring section.
